(19) United States
(12) Patent Application Publication
(10) Pub. No.: US 2018/0125047 A1
(43) Pub. Date: May 10, 2018

(54) LURE CONFIGURED AS A WOBBLER

(71) Applicant: Werner Gierl, Strasskirchen (DE)

(72) Inventor: Werner Gierl, Strasskirchen (DE)

(73) Assignee: Werner Gierl, Strasskirchen (DE)

(21) Appl. No.: 15/571,449

(22) PCT Filed: May 3, 2016
(86) PCT No.: PCT/EP2016/059855

§ 371 Date: Nov. 2, 2017

(30) Foreign Application Priority Data
May 5, 2015 (DE) 10 2015 005 695.6

(51) Int. Cl. A01K 85/16; A01K 85/18; A01K 91/04; A01K 95/00

(52) U.S. Cl. CPC A01K 85/16; A01K 85/18; A01K 83/00; A01K 95/00; A01K 91/04

(57) ABSTRACT

An artificial lure for fishing has a base body made from a floatable material and imitating a bait fish, at which at least one fishing hook is attached. In the head region of the base body, fastening eyelets for connection to a fishing line or a leader and a protrusion are provided. In the used state of the artificial lure in the water, the protrusion is configured diagonally upwards, and the fastening eyelet is situated below the protrusion. Preferably, a weighted insert for specifying the buoyancy and stabilizing the position in the water is provided in the base body. Furthermore, a system made up of such an artificial lure also includes a ground weight and a fishing line connected to a fishing rod.

The present invention relates to an artificial lure, also known as a wobbler, in the shape of a bait fish for fishing.

Known are artificial lures or also fishing baits which, in the shape of a bait fish, are used for fishing, in particular for fishing for predatory fish, and which, because of imitating the movement of the bait fish, are also referred to as wobblers. Such wobblers feature a wide variety of constructions, a plurality of different demands on the wobbler being reflected in a wide variety of constructions. Known wobblers for fishing predatory fish have special configurations which are to ensure that, when the artificial bait fish is reeled in after being casted out, that is, when it is drawn through the water, the artificial lure in a usual manner moves as much as possible like a natural prey fish.

DE 298 04 745 U1 describes an artificial lure for fishing for predatory fish, which, as a buoyancy body, is configured as a floatable body by omitting a weight, and which in the tail region has fibers extending over the body of the lure. These fibers, when moving the bait f by drawing the bait fish through the water or when in currents conditioned by bodies of water, are to stabilize the position of the bait fish, and that is in particular when this bait fish is fastened to a fishing line, which has a ground weight also referred to as a sinker, so that the bait fish rests as a buoyant body at a certain height above the bottom of the body of water and, as a result of the current and the fibers forming the tail, executes a wiggling swimming motion. If this bait fish now, for example by reeling in the fishing line, moves in the body of water, first only the ground weight moves across the water bottom, but not the bait fish. In this instance, the bait fish is protected from damage; however, if the tension force during reeling in is greater than the force of the ground weight, this fish is pulled in the direction of the tension force of the fishing line through the water and ultimately upwards to the surface of the water. This could prevent a predatory fish from following this not-necessarily-natural movement of the bait fish.

In order to achieve that such lures for fishing for predatory fish, when drawn through the water or if a ground weight is used, substantially follow a natural movement of a fish when the lure for fishing for predatory fish is standing still in a water current, it has been attempted to realize this movement of the fish by providing an additional fin-like part which, as a rule, is in the front region of the artificial lure. Such additional fin-like configuration at a known artificial lure, also referred to as diving lips, for example, is known from DE 123 635, DE 4236 848 C2, DE 203 14 054 U1, U.S. Pat. No. 5,99,2083 A, WO 2 005 03 22 47 A1, WO 99 56 536, US 2004/021 63 58 A1, DE 296 06 802 U1 and EP 1 112 685 A1. These known wobblers have in common that the fin-like diving lips, which are fastened in the front region of such wobblers, always point downwards, the fixing hook or fastening hook for the fishing line in the floating position being situated above the diving lips. In such an arrangement, if the fishing line is pulled for being reeled in or if the wobbler as a result of a water current is exposed to the current forces running in its longitudinal direction, as a rule, the wobbler in the water is guided downwards in the direction of the water bottom. This often results in getting caught in the water bottom, which not seldom, and to the annoyance of the fisherman, is connected to losing the wobbler.

A similar, known artificial fishing bait is described in DE 20 2004 003 251 D1, which as a so-called easy prey is to symbolize a sick or already dead fish, in that the fishing bait is floating having a lighter belly facing upwards and a darker back facing downwards, which is achieved by moving the center of gravity of the artificial fishing bait to the back. In the front region, this lure floating on the belly and attracting predatory fish also has a diving lip which points downwards in the direction facing away from the head. Above this diving lip, an attachment point for the fishing hook is mounted, so that when drawing this fishing bait through the body of water or when being flown against in flowing water, this lure in the body of water is always pulled downwards in the direction of the water bottom or to the water bottom, or it moves in the direction of the water bottom. Furthermore, US 2005 008 68 49 A1 describes a sport fishing hook for sninfishing which, for achieving a strong wobble movement in the water, has a bowed wingcase having an opening therein, through which the fishing line is guided to a lure mounted on a hook. This wingcase, made out of plastic material and from a thin plate having little buoyancy, may be configured as a bow or in a flat manner and, when drawn through the water, is to imitate the swimming movement of a prey fish. This artificial lure made from a plurality of parts does not have a weighted insert influencing the buoyancy and, because of the upwardly bowed front portion of the wingcase, is to move continuously upwards in the direction of the water surface when being pulled as a result of the required reeling in of the fishing line. A positioning in a defined height above the water bottom is not provided, so that demersal fish, for example zander or catfish, rather do not take the bait.

Against this background, the object of the present invention is to create an artificial lure in the shape of a wobbler, which under flow conditions in the water substantially remains at a desired depth and which imitates a natural movement of a prey fish, and that is without the wobbler moving in the direction of the bottom of the body of water

This object is achieved by an artificial lure having the features according to claim 1, and a system made up of an artificial lure and a fishing line connected to a fishing rod. Expedient further refinements are defined in the respective dependent claims for the artificial lure as well as for the system.

According to the present invention, the artificial lure provided for fishing, which is also referred to as fishing bait and is configured in the shape of a so-called wobbler, has a base body made from a floatable material, which is an imitation of a bait fish or a prey fish. The artificial lure according to the present invention has at least one fishing hook, which is fastened to the artificial lure, and is provided with a fastening eyelet in the head region of the base body for connection to a fishing line or a leader as part of the fishing line. The artificial lure has a shovel-like protrusion in the head region of the base body. According to the present invention, when the artificial lure is in the used state in the water, the protrusion points diagonally upwards and the fastening eyelet is situated below the protrusion. This means that the artificial lure is configured in such a manner that, when swimming at a defined water depth, it moves, for example when reeling in the fishing line, away from the water bottom or it stays above the water bottom. For this purpose, the angle under which the protrusion points upwards in relation to the horizontal longitudinal axis of the bait fish is configured in such a manner that, respective of the flow of the water relative to the artificial lure, the artificial lure remains in its substantially horizontal or slightly upwardly inclined alignment. This shovel-like protrusion adds to that the artificial lure remains in the desired depth of the body of water, for example when drawing the artificial lure by reeling in the fishing line but also during onflowing conditions when the artificial lure with the aid of a ground weight at the fishing line is so to speak anchored to the water bottom at a defined depth and is flown against by a water current. The material of the base body and its mass distribution in the longitudinal direction of the artificial lure are selected or dimensioned in direct coordination with the angle of flow of the shovel-like protrusion, the base body preferably being an imitation of a natural fish and having a density smaller than water and, for this reason, having a considerable buoyancy to again float upwards from the water bottom on account of its buoyancy after electing ground weight.

Preferably, the base body is manufactured from a floatable material in the form of a plastic material, wood or, for example, also Styrodur, or a combination of these materials.

This has the advantage that the base body can be produced in a simple manner and does not have to be configured as a hollow body. In so doing, a sealing against the ingress of water into such a hollow body is omitted, as the artificial lure being a hollow body would likely result in its loss.

A weighted insert is provided in the base body, which serves to specify the buoyancy of the base body and to stabilize the position of the base body in the water. By providing a weighted insert in the base body of the artificial body, the alignment of the artificial lure in the used state can, under flow conditions and by observing the angle of attack of the shovel-like protrusion, be exactly defined and influenced. Without flow conditions, the artificial lure is erected upwardly in the water; however, when drawing the artificial lure through the water, the artificial lure is moved by the shovel-like protrusion into a floating position away from the water bottom in the direction of the water surface. Having too little or no weight, the head part of the artificial lure could point downwards so that, even when the shovel-like protrusion is minimally upwardly angled, the artificial lure when moving through the current in the water would move downwards in the direction of the water bottom. For this reason, it is required to dimension the weighted insert in relation to or reference it against the buoyancy but also in relation to the floating position of the artificial lure in the used state as well as also in relation to the angle of attack of the shovel-like protrusion upwardly aligned. If a leader is present, the artificial lure, even at a low water flow rate, floats upwards until the length of the leader between the base weight and the fastening eyelet specifies the height above the water bottom, without the artificial lure sinking to the water bottom. In particular when reeling in the fishing line, the artificial lure is always removed from the water bottom.

Preferably, the weighted insert is situated in the rear third of the base body because, in so doing, the desired floating position for successful fishing, in particular for predatory fish, is best promoted.

Preferably, the base body has, in addition to the fastening eyelets for the fishing line situated below the shovel-like protrusion, further eyelets for fishing hooks, and one of the fishing hooks or only one single fishing hook can also be configured as a so-called treble fishing hook.

The artificial lure according to the present invention is, because of the positioning of the shovel-like protrusion in the head region of its base body, configured in a kite-like manner, so that the artificial lure within the scope of this application is also referred to as a so-called kite wobbler.

The artificial lure according to the present invention can, as a function of the size, be used for angling or fishing in fresh water and also for deep-sea fishing, in particular also for industrially operated deep-sea fishing and there it can, in particular, be used for longline fishing.

The fastening eyelet for the fishing line situated below the shovel-like protrusion at the head portion of the base body of the artificial lure advantageously serves also for the configuration of a leader with the aid of the fishing line if the fishing line has a ground weight in a defined distance from the fastening eyelet, with the aid of which a certain anchoring of the artificial lure on the water bottom is achieved. The length of the leader between the ground weight and the fastening eyelet for the artificial lure specifies the height of the artificial lure above the water bottom and, thus, the depth of the artificial lure in the water. Preferably, the ground weight is fastened to the fishing line with the aid of a swivel. As a result, it is possible that the artificial lure also moves around a temporary anchoring point in a radius defined by the length of the leader.

Preferably, the artificial lure is integrally formed, that is, the base body of the artificial lure and the shovel-like protrusion substantially form a rigidly configured part. It is however also possible that the base body is made up of two parts connectable to each other, the front portion of the base body being formed together with the shovel-like protrusion as the head portion and the fastening eyelet for the fishing line being configured below the head portion. At the end facing the tail portion of the base body, a coupling element is provided for connection to a tail portion as the second part of the artificial lure. The hinged and moveable connection of the head portion with the tail portion provides, given a present oncoming flow, a further additional movement of the artificial lure in its used state, which is adapted to the natural movement of a prey fish.

This artificial lure configured as a two-part design is also provided with a weight in the form of a weighted insert. In this instance, the head portion has a fastening eyelet for the fishing hook, while the weight or the weighted insert is provided in the rear third of the head portion. The rear portion of the two-part wobbler, that is the tail portion of the wobbler, in an interchangeable manner has, for example a so-called rubber fish or a twister. A twister serves to lend the wobbler an additional movement component when the water flows around the wobbler or when the wobbler is moved through the water.

The artificial lure according to the present invention wobbling upstream because of its wide shovel-like protrusion, and for this reason also referred to as a so-called kite wobbler, combines spinn fishing with demersal fishing, because the kite wobbler moves in the water even at a low flow rate and, owing to its certain anchoring by a ground weight, floats at a distance from the water bottom and, thus, cannot hook at the water bottom. The fishing line is connected to the leader line via the swivel at the ground weight.

Preferably, the leader line has at least a length of 120 cm so that the wobbler is at a far enough distance from the bottom of the body of water and a tearing of the fishing line can be prevented when reeling in the fishing line.

As a result of the kite wobbler, in addition to a weighted insert in the form of a lead or metal strip, preferably having a ground weight and, thus, having a higher weight than if the wobbler were only made of a floatable material, the wobbler can be cast over a much greater distance. A casting distance of approximately 100 m can easily be achieved. Conventional wobblers not having a counterweight nor a ground weight often feature a casting distance of no more than 30 m.

According to a second aspect of the present invention, a system according to the present invention has an artificial lure and a fishing line connected to a fishing rod. The artificial lure in its head portion has a protrusion which is configured in a manner similar to a shovel and/or similar to buoyancy wings and which widens towards the front edge. Below this protrusion, a fastening eyelet is provided which, when the fishing line including a corresponding ground weight is reeled in, defines a leader. The ground weight is provided with a swivel so that the artificial lure in a way can be kept at a defined depth on the water bottom corresponding to the length of the leader. The artificial lure when flown against in the water is, together with the upwardly directed shovel, kept at a defined floating position by the weight present in the base body of the artificial lure, that is, by a weighted insert present in the base body. The system according to the present invention is particularly advantageous if used in a body of water in which only relatively few currents are present. Already for relatively few currents, the artificial lure according to the present invention achieves that it moves by a wiggling swimming movement in the water flowing around it, which is very close to the natural swimming movement of a prey fish.

So that the artificial lure relative to its anchoring with the aid of the ground weight can move also corresponding to the length of the leader on a circular path, a swivel by its fastening eyelet is attached to the ground weight.

Preferably, the artificial lure has a fishing hook at the belly and/or in the tail region. In this instance, a fishing hook or a plurality of fishing hooks may be provided and may also be configured as so-called treble fishing hooks.

Further advantages and application possibilities are now explained in detail on the basis of two exemplary embodiments in the subsequent drawing.

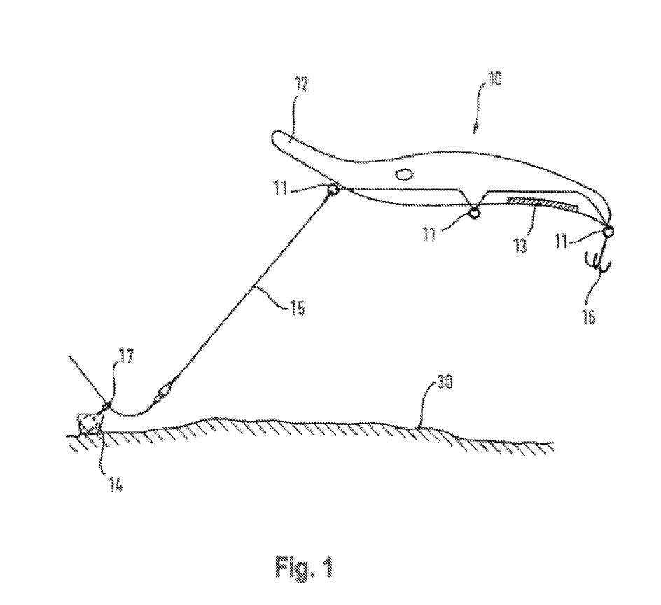

FIG. 1 shows an artificial lure according to the present invention, which is configured as a wobbler, as a floating system being anchored with the aid of a ground weight on the bottom of a body of water; and

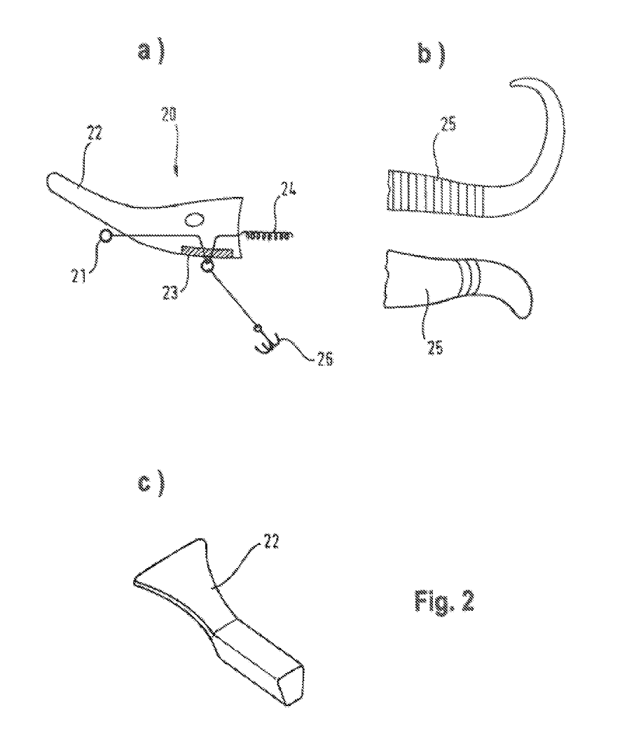

FIG. 2 shows a two-part wobbler having a head portion and a tail portion.

FIG. 1 shows a first exemplary embodiment of an artificial lure 10 according to the present invention configured as a wobbler or a kite wobbler. Wobbler 10 is made from a floatable material, for example, wood, plastic or Styrodur, and for this reason has a density lower than water. In its outer form, the wobbler imitates a bait fish regarding color and shape. In the rear region, wobbler 10 has a weighted insert, while, in the front region, the base body of the wobbler has a shovel-like protrusion 12 in the form of an extension. This shovel-like protrusion 12 is, in relation to the horizontal longitudinal axis of the wobbler, upwardly directed so that, in relation to a flow in a substantially horizontal floating state of the wobbler, a flow angle of attack is formed at the bottom side of the protrusion. Below shovel-like protrusion 12, a fastening eyelet for a leader line 15 is provided, which is part of the fishing line. This end portion of the fishing line, leader line 15, is connected to a ground weight 14 via a so-called swivel 17, from which point the fishing line is guided to the fishing rod. Ground weight 14 ensures a certain anchoring of wobbler 10 in a depth which, corresponding to the length of leader 15, is kept at a defined distance above water bottom 30.

Via a wire system present in the interior of the ground body of wobbler 10, further fastening eyelets 11 are provided respectively in the belly region of the wobbler and at the end of the wobbler. These further fastening eyelets serve the attachment of fishing hooks, of which a treble fishing hook 16 in principle is illustrated in an exemplary manner in rear fastening eyelet 11. Weighted insert 13 situated in the form of a strip in the interior of a wobbler, which may also be formed from lead, is in relation to its weight dimensioned in such a manner that the wobbler, taking into account an oncoming flow in the body of water, perhaps by reeling in the fishing line or by natural currents present in the water, is aligned or kept in a substantially horizontal position, meaning a position imitating the natural floating position of a prey fish. Thus, an exact dimensioning between size and angle of attack of the shovel-like protrusion and size and weight of weighted insert 13, including the material used for the base body of wobbler 10, is decisive.

The precise coordination of the respective parts or materials from which the wobbler is made is left to the preference of the average person skilled in the arts when he/she is confronted with the object to keep the wobbler in a substantially horizontal floating position, provided the conditions specified in FIG. 1.

If wobbler 10 according to FIG. 1 is moved across the water bottom by reeling in the fishing line, ground weight 14 also moves across the water bottom. In this instance, wobbler 10 remains substantially at the corresponding water depth above the water bottom, so that the risk of the wobbler hooking into the water bottom, plants, stones present on the water bottom or into other objects is largely eliminated. As a result, losing the wobbler when reeling in the fishing line is significantly reduced. The shovel or shovel-like protrusion 12 situated under an upwardly directed angle of attack ensures, in connection with the counterweight, an even buoyancy while the wobbler is moving through the water, so that, in addition to the substantially horizontal movement of the wobbler in the water, also a certain wiggling movement, like one usually made by a prey fish, is imitated. As a result, the wobbler undergoes a movement widely based on the natural movement of a prey fish, which is the basis for successful fishing.

For inland waters, when predatory fish, for example pikes, are to be caught, an appropriate length for such a wobbler can be 15 cm, and the weighted insert can be approximately 40 g. For this purpose, the use of lead has the advantage that a relatively high density advantageously provides the weight concentration required for the stability of the wobbler. In this instance, the shovel-like protrusion. may be approximately 3 to 4 cm in length and may widen to 2 to 2.5 cm in the direction of the front edge. Of course, this shape may vary and is a function of the targeted swimming movement in the body of water.

In FIG. 2, a two-part wobbler 20 is shown according to a second exemplary embodiment. The basic construction is similar to the wobbler according to FIG. 1; however, the wobbler is made up of two parts. This is firstly the head portion, which has a shovel-like protrusion 22 including fastening eyelets 21 situated at the bottom side of the shovel-like protrusion. Weighted insert 23 is located in the rear third of the front head portion. A further fastening eyelet, for example for a further treble fishing hook 26, is also located in this region. At the end of the head portion, a coupling element 24 is configured in the form of a corkscrew-like twisting, for which the wire, preferably a stainless steel wire, present in the interior of the base body of wobbler 20, is used for connecting fastening eyelets 21 to each other. A correspondingly configured tail portion in form of a so-called twister 25 or rubber fish can be fastened to coupling element 24. On account of the flexibility of the relatively thin wire for coupling element 24, an additional lateral tail movement is imitatable for emulating the natural movement of a prey fish. In conjunction with a special design of shovel-like protrusion 22 and twister 25, an additional lateral movement of the tail portion may be achieved in a manner relatively independent from the head portion when wobbler 20 moves through the water or when the water flows past wobbler 20. The head portion is shown in FIG. 2a; in contrast, tail portions 25 are shown in FIG. 2b. FIG. 2c shows a general top view of a shovel-like protrusion 22 for the head portion of wobbler 20, which widens in the forward direction.

If the angle of attack of shovel-like protrusion 12 or 22 is correspondingly selected, in coordination with the size of weighted insert 13 or 23, it is also possible that, when wobbler 10, 20 is accordingly flown against or drawn through the body of water, a rising the wobbler is realized if neither a leader nor a ground weight is used.

### LIST OF REFERENCE CHARACTERS

10 wobbler
11 fastening eyelet
12 shovel-like protrusion
13 weighted insert
14 ground weight
15 leader line
16 treble fishing hook
17 swivel
20 two-part wobbler
21 fastening eyelet
22 shovel-like protrusion
23 weighted insert
24 coupling element
25 tail portion
26 treble fishing hook
30 water bottom

1-12. (canceled)

13. An artificial lure (10, 20) for fishing under water, comprising a base body as an imitation of a bait fish, to which at least one fishing hook is attached, and comprising a fastening eyelet (11, 21) situated in the head portion of the base body for connection to a fishing line or a leader (15), and comprising a shovel-like protrusion (12, 22) situated in the head portion of the base body,
characterized in that,
the protrusion (12, 22) of the artificial lure (10, 20), in relation to its horizontal longitudinal axis and by forming an angle of attack thereto, points diagonally upwards, and the fastening eyelet (22, 21) is situated at the bottom side and below the protrusion (12, 22), and the protrusion (12, 22) widens in the forward direction towards its front edge.

14 The artificial lure (10, 20) as recited in claim 13, characterized in that the base body is manufactured from plastic, wood or Styrodur, or from a combination of these materials.

15. The artificial lure (10, 20) as recited in claim 13, characterized in that the base body is provided with a weighted insert (13, 23) for specifying the buoyancy, the stabilizing position in the water and the angle of attack of the protrusion (12, 22).

16. The artificial lure (10, 20) as recited in claim 15, characterized in that the weighted insert (13, 23) is situated in the rear third of the base body.

17. The artificial lure (10, 20) as recited in claim 16, characterized in that the weight insert in the artificial lure is situated and dimensioned in such a manner that the angle of attack of the shovel-like protrusion in an oncoming flow ensures an even buoyancy of the artificial lure under water, generating a substantially horizontal floating position.

18. The artificial lure as recited in claim 13, characterized in that the base body has a plurality of fastening eyelets (11, 21) for fishing hooks or is provided with at least one treble fishing hook (16, 26).

19. The artificial lure (10, 20) as recited in claim 13, characterized in that, at the fastening eyelet (11, 21) for a leader having a further weight as ground weight (14), a swivel (17) for a fishing line is attachable.

20. The artificial lure (20) as recited in claim 13, characterized in that the base body is made up of two parts connectable to each other, wherein the front part is configured as the head portion including the fastening eyelet (21) and the protrusion (22) and has a coupling element (24) for connection to a tail part (25).

21. The artificial lure as recited in claim 20, characterized in that the head portion has at least one fastening eyelet (21) for attaching a fishing hook and a weighted insert (23) situated in the rear third.

22. A system made up of an artificial lure (10, 20) as recited in claim 13 and of a fishing line connected to a fishing rod, characterized in that a leader is fastened at a fastening eyelet (11, 21) attached below a shovel similar to buoyancy wings (12, 22) at the head portion of the artificial lure (10, 20), and that the leader has the ground weight (14), which with the aid of a weighted insert (13, 23), present in the body of the artificial lure (10, 20) and stabilizing the floating position of the body, keeps the artificial lure when flown against in the water in conjunction with the upwardly pointing shovel (12, 22) at a defined water depth (page 3, line 25) in a substantially horizontal floating position.

23. The system as recited in claim 22, characterized in that the leader is fastened to the fastening eyelet (11, 21) with the aid of the swivel (17).

24. The system as recited in claim 22, characterized in that the artificial lure (10, 20) has a fishing hook in the belly region and/or the tail region.
